(19) United States
(12) Patent Application Publication
(10) Pub. No.: US 2006/0180382 A1
(43) Pub. Date: Aug. 17, 2006

(54) Telescopic loader, in particular a reach stacker

(76) Inventors: Andreas Scheidl, St. Gallenkirch (AT); Klaus Schneider, Hergatz (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/122,980

(22) Filed: May 3, 2005

(30) Foreign Application Priority Data
May 4, 2004 (DE) 10 2004 021 839.0

(51) Int. Cl. B60K 28/14; B60R 21/00

(52) U.S. Cl. 180/282

(57) ABSTRACT

The present application relates to a telescopic loader, in particular a reach stacker, consisting of a. vehicle frame, wheels arranged thereon, an engine and a telescopic boom pivotably arranged thereon with a load receiving means. The wheels can be driven by a hydrostatic drive which can be controlled via an undercarriage control with the undercarriage control having sensors for the detection of the actual states. In one example, it is advantageous to use a fuzzy logic unit to determine the rules of the driving property in dependence on a control command in combination with downstream controllers via which the commands can be directed on to the controlling elements of the hydrostatic drive.

### CROSS-REFERENCE TO RELATED APPLICATION

This application claims priority to German Application Serial No. 102004021839.0 filed May 4, 2004, the entire disclosure of which is hereby incorporated by reference into the present application, as provided in MPEP § 201.13.

### FIELD

The present application relates to a telescopic loader, in particular a reach stacker, comprising a vehicle frame, wheels arranged thereon, an engine, preferably a diesel engine, and a telescopic boom pivotably arranged thereon with a load receiving means for the transferring of heavy loads such as containers, trailers, sheet metal coils, part loads and the like.

### BACKGROUND AND SUMMARY

Reach stackers are vehicles with rubber tires, fitted with a diesel engine and an operator's cabin, similar to a retracted mobile crane. They can transport and stack containers. The previously known reach stackers are fitted with a container spreader fixedly connected to the telescopic arm, i.e. the spreader raising movement is only carried out via the telescopic arm. In known reach stackers, the operator's cabin is arranged fixedly or movably connected on the frame in the rear part on the vehicle, which always permits a good view for the operator of the container spreader fixedly connected to the telescopic arm with the current design.

With the known telescopic loaders, diesel engines are usually used which are connected to a mechanical transmission via conventional torque converters. The direction setting, i.e. a switching from traveling forward to traveling backward, takes place via an additional driving direction selection switch. The speed setting takes place using the gas pedal. Mechanical brakes are provided for the reduction of speed.

These previously known drives make only a low operating comfort for the driver necessary since he additionally has to set the desired speed and position of the reach stacker using a plurality of operating elements, namely using the steering wheel, the gas pedal and the driving direction selection switch, in addition to the actual handling of the load, i.e. a control of the boom by length and angle. Furthermore, on the use of the conventional gas pedal and of a conventional transmission, an energy-optimized operation of the telescopic loader is hardly possible or only with great restrictions. Finally, the wear of the previously used mechanical brakes is high and makes constant servicing or inspection necessary.

On object of the present application is to further develop a generic telescopic loader such that the operating comfort for its driver is substantially improved, with simultaneously an energy-optimized use of the reach stacker with low maintenance being possible.

This object is solved, in one example by a telescopic loader comprising a vehicle frame, wheels arranged thereon, an engine, and a telescopic boom pivotably arranged thereon with a load receiving means for the transferring of heavy loads, where the wheels can be driven via a hydrostatic drive which can be controlled via an undercarriage control, with the undercarriage control having sensors for the detection of the actual states which passes the commands to the controlling elements of the hydrostatic drive via a logic unit in which logic algorithms and controller algorithms run.

In accordance with this solution, the wheels can be driven by a hydrostatic drive which can be controlled via an undercarriage control with the undercarriage control being able to have sensors for the detection of the actual states. A fuzzy logic unit may advantageously be used to determine the rules of the driving property in dependence on a control command in combination with downstream controllers via which the commands can be directed on to the controlling elements of the hydrostatic drive. However, there is also the possibility of implementing the processing of the sensor system and the calculation of the corresponding actuation values resulting therefrom via differently structured logic or control algorithms. Further, by equipping the telescopic loader with a hydrostatic drive, the reach stacker can be operated at the optimum operating point during travel. This optimum operating point may be clearly defined in the infinitely variable transmission by the position of the hydrostatic transmission and the speed of the diesel engine. Moreover, a hydrostatic and thus low-wear braking is possible. Finally, a space-saving compact construction is possible due to the provision of the hydrostatic drive. The undercarriage control processes the actual states detected by the sensors and determines driving property rules in dependence on a control command. These corresponding rules are passed on, e.g. by the fuzzy logic unit, to the downstream controllers via which the commands can be passed on to the controlling elements of the hydrostatic drive.

As noted above, in one example the rules for the driving properties are advantageously defined in the fuzzy logic unit. These can, for example, be the acceleration or hydrostatic braking, or combinations thereof. The diesel engine speed can be increased in dependence on the driving states, for example, uphill/downhill driving. A compensation of spinning wheels can take place. On the other hand, driving under load can be defined as a driving property. Driving curves and the tilt boundaries to be taken into account in it are to be counted among the driving properties to be defined.

In accordance with a further advantageous aspect of one embodiment, the fuzzy logic unit can additionally define the weighting of the different controllers.

Also, the undercarriage control can take place centrally via an operating element. The operating element for the central operation of the undercarriage control may advantageously be a joystick.

A significantly higher driving comfort can be defined for the driver via the undercarriage control in accordance with the present application since it can now determine the speed and position of the reach stacker via an operating element, for example a joystick.

### DESCRIPTION OF THE FIGURE

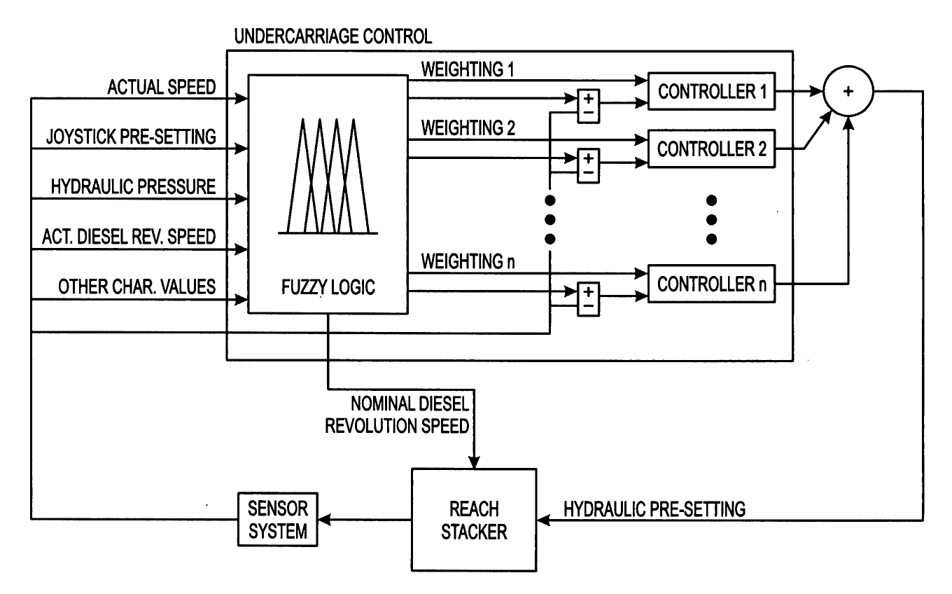

Further features, details and advantages result from the embodiments shown in the drawing. An undercarriage control of a reach stacker is represented schematically in the FIG. 1.

### DETAILED DESCRIPTION

The reach stacker comprises a vehicle frame, an optional load support, a telescopic arm and an operator's cabin. A load receiving means is hinged to the telescopic arm and a load can be taken up by it.

The system of the undercarriage control is shown in the Figure by a corresponding flowchart, with it here being an elementary representation in which the individual components of the reach stacker are not designated in detail.

For instance the sensors, for example for the detection of the actual speed, the hydraulic pressure, the actual diesel engine speed, a joystick pre-setting and other characteristic parameters, are shown schematically by the sensor system. The actual values picked up by the sensors such as the actual speed, the joystick pre-setting, the hydraulic pressure, the actual diesel engine speed and other characteristic values are supplied to the undercarriage control and are processed there.

In one example embodiment, it is advantageous to evaluate the instantaneous driving state (e.g. acceleration, uphill/downhill driving, braking, etc.) via a fuzzy logic unit and to pass on corresponding control pre-settings to the most varied controllers. The hydraulic presetting is determined for specific driving situations in accordance with the output of the undercarriage control and is passed on to controlling elements of the reach stacker 10 not shown in any more detail here. The operation of the reach stacker with respect to speed and position is advantageously possible by only one single joystick (not shown in any more detail here).

1. A telescopic loader, comprising a vehicle frame, wheels arranged thereon, an engine, and a telescopic boom pivotably arranged thereon with a load receiving means for the transferring of heavy loads where the wheels can be driven via a hydrostatic drive which can be controlled via an undercarriage control, with the undercarriage control having sensors for the detection of the actual states which passes the commands to the controlling elements of the hydrostatic drive via a logic unit in which logic algorithms and controller algorithms run.

2. A telescopic loader in accordance with claim 1, wherein a fuzzy logic is used as a logic unit for the determination of the rules of the driving properties in combination with downstream controllers.

3. A telescopic loader in accordance with claim 2, wherein rules for the driving properties, including acceleration, hydrostatic braking, changing the engine speed in dependence on the gradient, driving under load or compensation of spinning wheels are defined in the undercarriage control.

4. A telescopic loader in accordance with claim 3, wherein the undercarriage control takes place centrally via an operating element.

5. A telescopic loader in accordance with claim 4, wherein the operating element for the central operation of the undercarriage control includes a joystick.

6. A telescopic loader in accordance with claim 3, wherein the undercarriage control takes place centrally via a plurality of operating elements.

7. A telescopic loader in accordance with claim 1, wherein the telescopic loader is a reach stacker.

8. A telescopic loader in accordance with claim 1, wherein said load includes at least one of containers, trailers, sheet metal coils, and part loads.

9. A telescopic loader in accordance with claim 1, wherein said engine is a diesel engine.

10. A method for controlling a telescopic loader, said loader having a vehicle frame, wheels arranged thereon, an engine, a hydrostatic drive, and a telescopic boom pivotably arranged thereon with a load receiving means for the transferring of heavy loads, the method comprising:
sensing states of the loader;
adjusting the hydrostatic drive in response to said sensed states using algorithms.

11. The method of claim 10, wherein algorithms include logic and control algorithms.

12. The method of claim 11, wherein said hydrostatic drive is adjusted to provide acceleration or hydrostatic braking.

13. The method of claim 10, wherein said adjusting compensates for spinning of the wheels.

14. The method of claim 10, wherein said adjusting compensates for driving curves or tilt boundaries.

15. The method of claim 10, wherein said sensed states include sensing a joystick actuated by a vehicle operator, and where said algorithms use fuzzy logic.

16. A method for controlling a telescopic loader, said loader having a vehicle frame, wheels arranged thereon, an engine, a hydrostatic drive, and a telescopic boom pivotably arranged thereon with a load receiving means for the transferring of heavy loads, the method comprising:
sensing states of the loader including an operator input;
adjusting the hydrostatic drive and the engine in response to said sensed states.

17. The method of claim 16, wherein said sensed states include sensing a joystick actuated by a vehicle operator.

18. The method of claim 16, wherein said sensed states include whether the loader is under acceleration, uphill/downhill driving, or braking.

19. The method of claim 16, wherein said sensed states include actual values picked up by sensors, including actual speed and a joystick pre-setting.

20. The method of claim 16, wherein said sensed states include actual values picked up by sensors, including hydraulic pressure and actual diesel engine speed, and where said algorithms use fuzzy logic.
